(19) United States
(12) Patent Application Publication
(10) Pub. No.: US 2009/0278367 A1
(43) Pub. Date: Nov. 12, 2009

(54) Apparatus for picking up man made or other objects placed on any environmental surface and process for using the apparatus

(76) Inventors: Donald Wayne Bain, Oxford, AL (US); Jennifer Allise Bain, Oxford, AL (US); Jessica Leigh Bain, Oxford, AL (US)

Correspondence Address: Donald Wayne Bain, 917 Boozer Drive, Oxford, AL, 36203, US

(21) Appl. No.: 12/151,784

(22) Filed: May 9, 2008

(51) Int. Cl. B25B 9/02

(52) U.S. Cl. 294/24; 294/2

(57) ABSTRACT

Apparatus lifting objects with wire forming two looped, springy wire elements crossing in “x”, ending in loops with terminus 304 degrees leaving 56 degree hooks, handle of any length or material, Strong magnet glued in handle top, countersunk ⅛″, backup securement by 2 Allen screws through handle, steel removable cover for magnet, tapped receiving common arrowhead with steel point, Metal termination plate/end cap at bottom terminus of handle forming platform anchoring several apparatus elements, Sharply pointed arrowhead for piercing and picking items as paper, plastic, etc, Flexible, curved entrapment medium attached to termination plate/endcap of handle perpendicular to loops by screw and washer, Screw with washer and spacer attaching wire tops to handle allowing flexible wire movement, screw and washer attaching entrapment medium to attachment plate, 2 short pieces of hook/loop tape wrapping steel end cap, arrowhead maintaining contact with magnet preventing loss of point.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of environmental cleanup for homeowners, farmer, commercial or governmental property, or roadsides and more specifically to an apparatus for easily picking up and segregating man made or other objects for recycling when such objects are placed on any environmental surface and a process for using the apparatus for maintaining operator safety while reducing fatigue. I have tried all types of available machines or devices for picking up litter from my lawn and as an environmentalist, from roadsides in my immediate surroundings. All available tools worked poorly or not at all on differing types of common litter and debris found throughout America. I researched the physical nature of objects thrown out as trash and developed one apparatus to enable a person to pick up all common objects except liquids or broken glass. I designed my apparatus to require no squeezing or torque forces to be applied to prevent hand injuries to the operator. One can take my apparatus and clean an area of all commonly found debris, and separate the aluminum, plastic, glass, and ferrous objects with the apparatus at the time of pickup, saving countless hours of resorting later. My apparatus is extremely simple in design, very easy to manufacture, and requires little or no maintenance. It is strong and durable and will last for many years with no maintenance. All parts are off the shelf items except the convoluted wire design which I developed to allow the physical nature of the object to be picked up, to cause it to be picked up. However, the wire design is so simple that the convoluted wire can be made from a single piece of strong springy wire formed around an appropriately laid out template. All other parts are commonly available and can simply be replaced by the purchaser if the need should ever arise. I built my working model in less than one hour, and was astounded at how well it works. It simply will pick up anything except liquids and broken glass.

The “Gopher” operates by using a squeeze handle transmitting this force to the opposite end of the handle by means of a wire cable inside a hollow handle. This cable pulls two claw like pinchers together to provide the force needed to pick up an object.

The spike type litter gatherer is simply a sharpened spike attached to a handle and stabbed through an object to pick it up.

Magnetic pickup devices are simply magnets attached to a handle regardless of overall shape or form and work only on iron or iron based objects.

Large truck/tractor or lawnmower mounted vacuum devices are used mainly on city streets and commercial parking lots and are of no use to the average homeowner or concerned environmentalist trying to pick up and/or recycle objects from the environment.

Magnetic devices pick up only iron or ferrous objects leaving all the rest behind

The “Gopher” works primarily on smooth, evenly shaped objects, flat or oddly shaped objects tend to drop from the suction cups on the pincers. The repeated squeezing force required is very painful to arthritic hands and even in healthy hands, could lead to a repetitive stress injury if used often enough.

The “spike” type devices works primarily on flat soft objects as they cause 3 dimensional or tough objects to merely “scoot” away when jabbed. They are no use at all on tough steel as they cannot penetrate it. This device is dangerous and could be used as a spear or object of war by the very nature of the blade with no protective sheath

Vacuum devices are prohibitively expensive, cumbersome, and mix recyclable objects together with even more debris such as leaves, lawn clippings, dust, bird droppings, etc

All of these technologies are so limited that an operator could own all of these devices and still have to hand pick items to clean the environment and separate the recyclable materials from the litter.

### BRIEF SUMMARY OF THE INVENTION

The primary object of the invention is To allow a person regardless of strength or agility to easily pick up objects from man made, natural grass, or bare surfaces.

Another object of the invention is To require no exhaustive physical force, squeeze, twist, or torque from the operator to perform the task.

Another object of the invention is To allow operator to pick up various types of man made or natural trash, debris, or litter regardless of metallic, plastic, leafy or paper composition.

A further object of the invention is To discriminate between ferrous and non-ferrous metals at time of pick up.

Yet another object of the invention is To provide operator safety by means of an easily removable and replaceable very sharp point for collecting thin flimsy materials such as fast food wrappers, cups, leaves, or clamshell Styrofoam containers.

Still yet another object of the invention is To bring together all functions in an apparatus weighing less than two pounds.

Another object of the invention is To enable operator to use one apparatus to gather all common types of litter in the environment.

Another object of the invention is To prevent repetitive stress injuries or fatigue caused by using any other apparatus currently available.

A further object of the invention is To have durability and simplicity without the moving cables or squeeze handles of competing devices such as to require almost no maintenance or adjustments.

Yet another object of the invention is To provide ease of use to enable almost any person to use the apparatus by simply placing it over an object to collect and lift it up with a force equaling only the combined weight of the apparatus and the object picked up.

Still yet another object of the invention is To provide simplicity of manufacturing process allowing apparatus to be manufactured rapidly by forming wires around a simple template, with common materials, and simple to manufacture or easily modifiable available fastening systems incorporated into apparatus.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for picking up man made or other objects placed on any environmental surface comprising: A wire of a convoluted designed such as to form two curved, looped springy wire elements crossing each other in an “x” fashion and ending in loops at the terminus approximating 304 degrees thereby leaving approximate 56 degree openings to function as hooks. A simple light weight handle comprised of wood, of any desired length desired, A very strong lightweight magnet attached to the end of the handle countersunk ⅛″ and glued in place with backup securement by 2 Allen set screws through handle, A steel removable cover for the magnet, tapped to receive a common aluminum deer hunting arrowhead with carbon steel point, A metal termination plate/end cap at the bottom terminal end of the handle to form a platform to anchor together the several apparatus elements, A sharply pointed hunting arrowhead with razor blades removed to pierce and pick up flimsy items as paper, plastic, etc, A flexible but durable slightly curved entrapment medium attached to the termination plate/endcap of the handle perpendicular to the wire loops by means of a simple screw and washer, A screw with large washer and a spacer to attach the tops of the looped wire to the handle allowing flexible movement of the wire, A screw and washer to attach the entrapment medium to the bottom terminus of the attachment plate, Two short pieces of hook and loop fastening tape to wrap over steel end cap and arrow head to maintain close contact with magnet to prevent them from working loose and being lost.

In accordance with a preferred embodiment of the invention, there is disclosed a process for picking up debris objects from environment consisting of:
Placing the wire loops over solid objects to be picked up, the weight of the apparatus causes the wires to deform slightly causing the object to snap into the opening and press against the entrapment medium where it is held until pushed out by the operator. The neodymium magnet on top end of handle will pick up heavy irony objects and discriminate between iron an other metals. The arrowhead attached to steel end cap is held by magnetic force to the neodymium magnet when needed and is used to pierce paper, Styrofoam, plastic, etc. Objects as shopping bags, six pack plastic holders, milk jugs are easily “hooked” by the 56 degree hooks on both sides of the apparatus.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

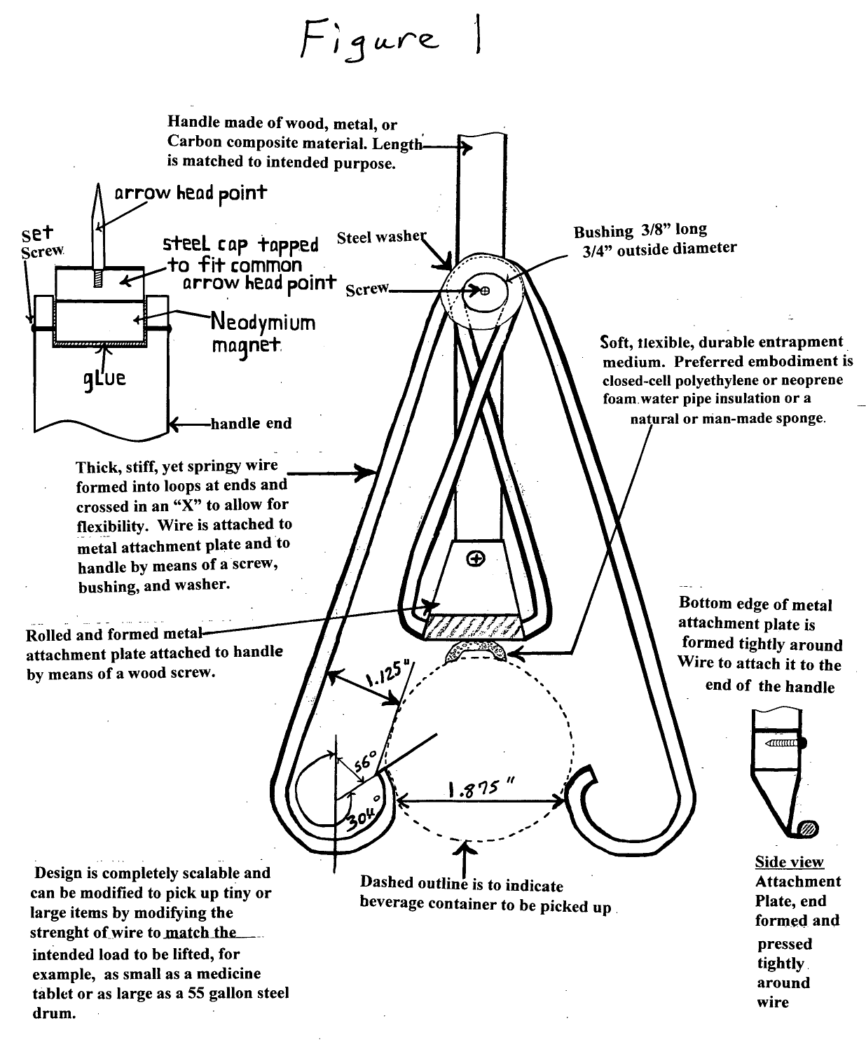

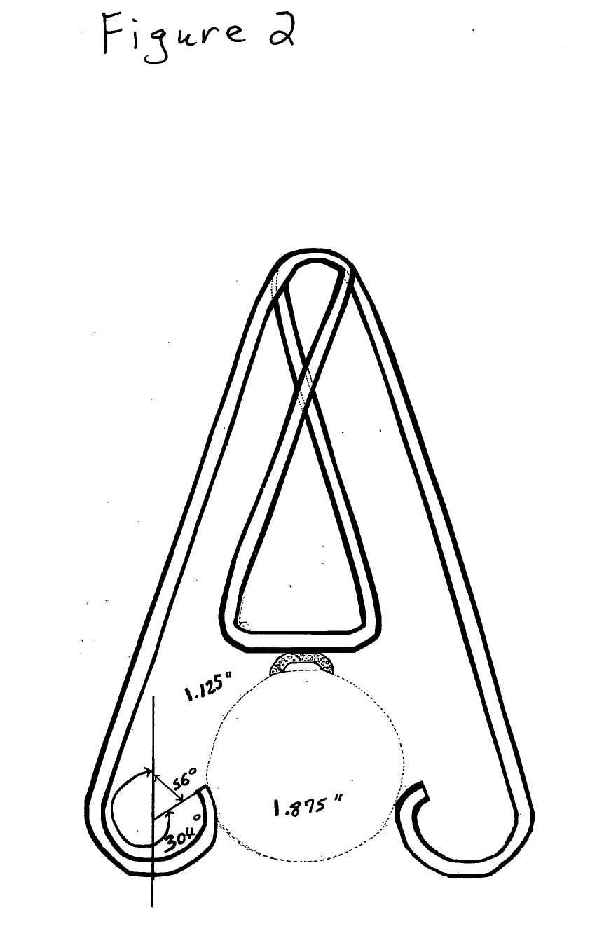

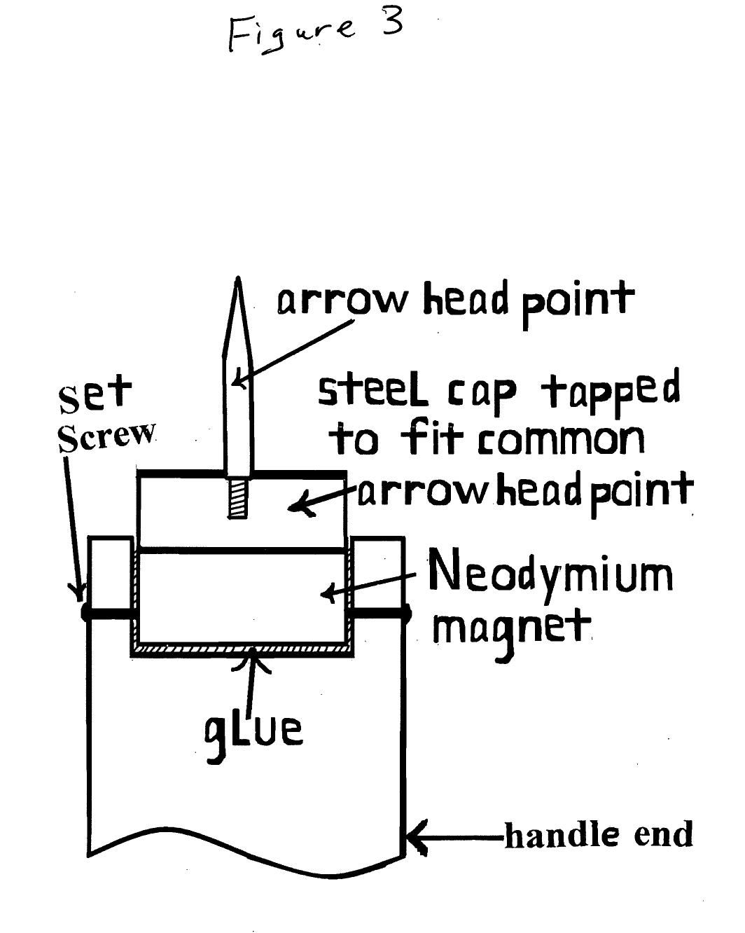

Turning first to FIG. 1, there is shown the overall design of the apparatus showing the simplicity and method of manufacture and use.

In accordance with an important feature of the present invention, there is shown in FIG. 2, the first distinctive, inventive element the convoluted, curved, stiff yet springy, looped wire designed to form two flexible wire elements crossing in an “x” fashion, each with terminal ends forming loops approximating 304 degrees, thereby leaving approximate 56 degree openings that function as “hooks” to pick up plastic shopping bags, string, fishing line, or any object subject to being “hooked”. For picking and holding solid objects such as beverage cans or bottles made of glass or plastic, this same wire design is the the heart of my apparatus because together with the employment of the soft, durable, slightly curved entrapment medium (attached to the metal termination plate by a screw and washer), is the secret to holding the object firmly in the grip of the wire loops, thereby comprising the elements of a pickup device. This wire is attached to the handle by means of a large washer, spacer, and a wood screw at the tops of the two wires. This design allows flexible movement of the wires causing them to conform to the shape of whatever solid object is lying in the environment. The entrapment medium is oriented perpendicular to the plane of the 2 wire loops for added holding power. The formed metal attachment plate is a platform which serves as an anchor point to attach the several parts of the apparatus together.

To accomplish an important function of the invention, there is shown in FIG. 3, the second inventive element a removable “spike” or sharp point to allow for operator safety and to expose the very strong neodymium magnet which is countersunk ⅛″ in the top terminus end or the handle and glued in place (with two Allen head set screws for backup securement) for lifting heavy irony objects and sorting iron from non-ferrous metals on the spot. The removable sharp point is a common deer hunting arrowhead (with razor blades removed) threaded into a tapped hole (hole is sized to receive the point) in the solid steel cap which is held in place by the extreme magnetic fields of the Neodymium rare earth magnet and further secured by 2 short pieces of common hook and loop fastening tape which the operator will wrap over the solid steel endcap (the arrow point goes through holes in the tape to secure it in close contact with the neodymium magnet and prevent it from working loose and becoming lost.

In accordance with the present invention, FIG. 3 shows the third inventive element employment of the the incredible strength of a rare earth Neodymium magnet to both pick up ferrous metals and alternately hold the removable sharp point in place. My apparatus allows the operator to take only one apparatus to clean an area and also sort the collected items at the point of collection, saving countless hours of resorting later. The light weight handle of any desired length comprised of wood, lightweight metal, or carbon composite material along with other very simple parts keep the total weight under two pounds. A wooden handle is the preferred embodiment. The removable sharply pointed arrow head which is tightened into a tapped hole threaded to receive it in the solid steel endcap, is only attached when needed, thereby protecting the operator and others nearby from unintended injuries caused by such sharp equipment with a dangerous point. The extreme sharpness is an absolute necessity to pierce wet paper napkins, flimsy aluminum foil, fast food wrappers, Styrofoam containers, and other such litter because they will deform or rip when jabbed by a blunt device.

The process to use my apparatus is simply to place the wire loops over the object to be picked up and let the weight of the apparatus deform the wire loops causing the object to “snap” up between them against the entrapment medium and then lift the object up and place it where the operator wants it to go. The other end of the apparatus handle contains the magnet which the operator can use to pick up iron or irony objects and further to sort metals into iron or non-ferrous metal at the time. The removable arrow point is simply “stuck” to this same magnet and used to jab or stab flimsy, wet, paper, plastic, Styrofoam, or other such materials

My apparatus is a one of kind device that will contribute enormously to cleanup efforts worldwide as it can pick man made debris placed on any environmental surface and is very simple and cheap to manufacture and maintain. It can be assembled by hand without the aide of expensive machines. All parts are easily replaced with common ordinary items of everyday commerce from large “big box retailers” or sporting goods retailers. Even the wire can be hand formed, I made my first model by hand completely from sketch to a working apparatus in less than one hour. I have made models with used coat hanger wire that function perfectly.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for picking up man made or other objects placed on any environmental surface comprising:
A wire of a convoluted designed such as to form two curved, looped springy wire elements crossing each other in an “x” fashion and ending in loops with the terminus approximating 304 degrees thereby leaving approximate 56 degree openings to function as hooks;
A simple light weight handle comprised of any desired length or material desired;
A very strong lightweight magnet attached to the end of the handle, countersunk ⅛″ and glued in place with backup securement by 2 Allen set screws through handle;
A steel, removable cover for the magnet, tapped to receive a common aluminum deer hunting arrowhead with carbon steel point;
A metal termination plate/end cap at the terminal end of the handle to form a platform to anchor together the several apparatus elements;
A sharply pointed hunting arrowhead with razor blades removed to pierce and pick up flimsy items as paper, plastic, etc;
A flexible but durable, slightly curved entrapment medium attached to the termination plate/endcap of the handle perpendicular to the wire loops by means of a simple screw and washer;
A screw with large washer and a spacer nut to attach the tops of the looped wires to the handle allowing flexible movement of the wire;
A screw and a washer to attach the entrapment medium to the end terminus of the attachment plate;
A screw with large washer and a spacer to attach the tops of the looped wires to the handle allow flexible movement of the wire; and
Two short pieces of hook and loop fastening tape to wrap over steel end cap and arrow head to maintain close contact with magnet to prevent them from working loose and being lost.

2. A process for picking up debris objects from environment consisting of: Placing the wire loops over solid objects to be picked up, the weight of the apparatus causes the wires to deform slightly causing the object to snap into the opening and press against the entrapment medium where it is held until pushed out by the operator. The neodymium magnet on top end of handle will pick up heavy irony objects and discriminate between iron an other metals. The arrowhead attached to steel end cap is held by magnetic force to the neodymium magnet when needed and is used to pierce paper, Styrofoam, plastic, etc. Objects as shopping bags, six pack plastic holders, milk jugs are easily “hooked” by the 56 degree hooks on both sides of the apparatus.
